(19) United States
(12) Patent Application Publication
(10) Pub. No.: US 2019/0279038 A1
(43) Pub. Date: Sep. 12, 2019

(54) DATA FLOW GRAPH NODE PARALLEL UPDATE FOR MACHINE LEARNING

(71) Applicant: Wave Computing, Inc., Campbell, CA (US)

(72) Inventor: Christopher John Nicol, Campbell, CA (US)

(21) Appl. No.: 16/423,050

(22) Filed: May 27, 2019

Related U.S. Application Data
(63) Continuation-in-part of application No. 16/104,586, filed on Aug. 17, 2018.
(60) Provisional application No. 62/827,333, filed on Apr. 1, 2019.
(60) Provisional application No. 62/802,307, filed on Feb. 7, 2019.
(60) Provisional application No. 62/800,432, filed on Feb. 2, 2019.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/547,769, filed on Aug. 19, 2017.

(51) Int. Cl. G06K 9/62; G06N 3/08; G06N 3/04; G06F 16/901

(52) U.S. Cl. CPC G06K 9/6257; G06F 16/9024; G06N 3/04; G06N 3/08

(57) ABSTRACT

Techniques are disclosed for data flow graph node parallel update for machine learning. A first plurality of processing elements is configured to implement a portion of a data flow graph. The nodes include at least one variable node and implement part of a neural network. A second plurality of processing elements is configured to implement a second portion of the data flow graph. These nodes include at least one additional variable node and implement an additional part of the neural network. Training data is issued to the first plurality of processing elements. The training data is used to update variables within the at least one variable node. Additional variables are updated within the at least one additional variable node. The updating includes forwarding training data from the first plurality to the second plurality. The neural network is trained based on the variables that were updated and the additional variables.

### RELATED APPLICATIONS

This application claims the benefit of U.S. provisional patent applications “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, “FIFO Filling Logic for Tensor Calculation” Ser. No. 62/802,307, filed Feb. 7, 2019, and “Matrix Multiplication Engine Using Pipelining” Ser. No. 62/827,333, filed Apr. 1, 2019.

This application is also a continuation-in-part of “Reconfigurable Fabric Data Routing” Ser. No. 16/104,586, filed Aug. 17, 2018, which claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to data flow graph node parallel update for machine learning.

### BACKGROUND

Researchers, businesspeople, and governments collect and analyze vast amounts of data. The data is most typically collected from people as they interact with their personal and other electronic devices. The interactions can be online, in public, or at home. The collection of public, personal, and other data has become so commonplace that the collection frequently goes unnoticed until there is a problem. An individual may be using her smartphone to research world events, while another person is using his tablet to order pet food or toner cartridges. Irrespective of the particular activity, metadata about the user interactions with their devices is collected. Data and metadata include details such as websites visited, products and services searched or viewed, and radio buttons clicked. All of this data is collected and analyzed for purposes of monetization, security, or surveillance, among others. Analysis results are used to push online content, products, or services that are predicted to match user interests.

Emerging software analysis techniques and processor architectures are propelling the collection of personal and other data at an accelerating rate. Businesspeople, researchers, and governments aggregate the collected data into datasets that are often referred to as “big data”. The big data datasets can then be analyzed. The sizes of the big data datasets overwhelm the capabilities of the traditional processors and analysis techniques, making the analysis economically infeasible. Other data handling requirements, such as the access, capture, maintenance, storage, transmission, and visualization of the data, among other tasks, further complicate the computational and processing requirements. Any one of these data handling requirements can quickly saturate or exceed the capacities of the traditional systems. The collected data would be of little or no fundamental value without viable and scalable data analysis and handling techniques. Innovative computing architectures, as well as software techniques, algorithms, functions, routines, and heuristics, are necessitated. Dataset stakeholders are motivated by business, research, and other interests to analyze the data. Common data analysis purposes include business analysis; disease or infection detection, tracking, and control; crime detection and prevention; meteorology; and complex scientific and engineering simulations; among many others. Advanced data analysis techniques are finding applications such as predictive analytics, which can be used to show consumers what they want, even before the consumers know that they want it. Further approaches include applying machine learning and deep learning techniques in support of the data analysis.

Advanced processing hardware has been introduced, as have software learning techniques, which have been a boon to many computer science disciplines including machine learning. Machine learning posits that a machine on its own can “learn” about a unique dataset. The machine learning occurs without requiring that the machine be explicitly coded or programmed by a user to handle that dataset. Machine learning can be performed on a network of processors such as a neural network. The neural network can process the big data datasets so that the neural network can learn about the data contained within the dataset. The greater the quantity of data, and the higher the quality of the data that is processed, the better the outcome of the machine learning. The processors on which the machine learning techniques can be executed are designed to efficiently handle the flow of data. These processors, which are based on data flow architectures, process data when valid data is presented to the processor. Data flow architectures enable simplifications to a processing system such as avoiding a need for a global system clock.

Computing architectures based on reconfigurable hardware are highly flexible and particularly well suited to processing large data sets, performing complex computations, and executing other computationally resource-intensive applications. Reconfigurable computing integrates the key advantages drawn from hardware and software techniques. A reconfigurable computing architecture can be “recoded” (reprogrammed) to suit a processing need. The recoding adapts or configures the high-performance hardware architecture, much like recoding software. A reconfigurable fabric hardware technique is directly applicable to reconfigurable computing. Reconfigurable fabrics may be arranged in topologies or configurations for the many applications that require high performance computing. Applications such as processing of big data, digital signal processing (DSP), machine learning based on neural networks, matrix or tensor computations, vector operations, Boolean manipulations, and so on, can be implemented within a reconfigurable fabric. The reconfigurable fabric fares particularly well when the data includes specific types of data, large quantities of unstructured data, sample data, training data, and the like. The reconfigurable fabrics can be coded or scheduled to achieve these and other processing techniques, and to represent a variety of efficient computer architectures.

### SUMMARY

A data flow graph shows operations performed on data. The data flow graph includes nodes that represent the logical, mathematical, Boolean, and other operations to be performed on data, and arcs that represent the flow of the data between and among the nodes. A data flow graph is a useful visual representation that is particularly well suited to understanding a variety of highly complex computing tasks. The data flow graph represents the calculations and flow of data required to perform those tasks. Machine learning is one particularly complex computational example that can be represented using data flow graphs. Machine learning is a technique by which a computing system, such as a reconfigurable fabric, can be configured to “learn”. That is, the computing system adapts itself, as it processes data, to improve inferences, computational performance, convergence, and so on. Machine learning systems can be based on neural networks such as convolutional neural networks (CNNs), deep neural networks, (DNNs), a recurrent neural network (RNN), and so on.

A reconfigurable fabric can be configured or “coded” to implement a given data flow graph. A reconfigurable fabric can also be reconfigured by adapting it or “recoding” it to implement a given data flow graph. The data flow graph itself can be adapted by changing code used to configure elements of the reconfigurable fabric, parameters, or values, such as weights, scales, or biases processed by the data flow graph, etc. The reconfigurable fabric can include computational or processor elements, storage elements, switching elements for data transfer, control elements, and so on. The reconfigurable fabrics are coded to implement a variety of processing topologies for machine learning. The reconfigurable fabric can be configured by coding or scheduling the reconfigurable fabric to execute a variety of logical operations such as Boolean operations, matrix operations, tensor operations, mathematical operations, gradient calculations, etc. The scheduling of the reconfigurable fabric can be changed based on a data flow graph.

Data flow graph node parallel updates are performed for machine learning. Embodiments include a processor-implemented method for data manipulation comprising: configuring a first plurality of processing elements within a reconfigurable fabric to implement a first portion of a data flow graph, wherein the nodes of the first portion of the data flow graph include at least one variable node, and wherein the first portion of the data flow graph implements part of a neural network; configuring a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network; issuing training data to the first plurality of processing elements, wherein the training data is used to update variables within the at least one variable node; and updating additional variables within the at least one additional variable node, wherein the updating is based on forwarding the training data from the first plurality of processing elements to the second plurality of processing elements. Some embodiments include training the neural network based on the variables within the at least one variable node that were updated and the additional variables within the at least one additional variable node. Other embodiments include passing gradients from the second plurality of processing elements to the first plurality of processing elements, wherein the gradients are used to further update variables within the at least one variable node. Still other embodiments include forwarding additional training data from the first plurality of processing elements to the second plurality of processing elements, wherein the additional training data is based on data from the variables, within the at least one variable node, that were further updated.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for data flow graph node parallel update for machine learning.

FIG. 2 is a flow diagram for parallel neural network training.

FIG. 3 shows variable updating using training minibatches.

FIG. 4A illustrates scaling of variable training.

FIG. 4B is a block diagram for a data flow processing unit including loss.

FIG. 5 shows a network for a data flow graph.

FIG. 6 illustrates a deep learning program graph.

FIG. 7 shows an assembled data flow graph for runtime.

FIG. 8 illustrates batch processing for training.

FIG. 9 shows execution manager operation.

FIG. 10 shows a cluster for coarse-grained reconfigurable processing.

FIG. 11 shows a block diagram of a circular buffer.

FIG. 12 illustrates circular buffers and processing elements.

FIG. 13 shows a deep learning block diagram.

FIG. 14 is a system for a data flow graph node parallel update for machine learning.

### DETAILED DESCRIPTION

Techniques are disclosed for data flow graph node parallel update for machine learning. Data flow graph node parallel update can be performed on a server, a computing device, a reconfigurable computing device, an integrated circuit or chip, and so on. A reconfigurable computing device can include a reconfigurable fabric which incorporates critical performance and coding features of both hardware techniques and software techniques. The hardware techniques include computer architectures carefully designed for high performance computations. The included software techniques enable the hardware to be reconfigured easily for specific computational tasks such as processing data flow graphs, executing neural networks, performing machine learning, and so on. A reconfigurable fabric can include one or more element types, where the element types can include processing elements, storage elements, switching elements, control elements, and so on. An element can be configured to perform a variety of architectural and computational operations based on the type of element and by programming, coding, or “scheduling” the element. The reconfigurable fabric can include quads of elements, where the quads include processing elements, shared storage elements, switching elements, circular buffers for control, communications paths, registers, and the like. An element or subset of elements within the reconfigurable fabric, such as a quad of elements, can be controlled by providing code to one or more circular buffers. The code can be executed by enabling—or configuring—the circular buffers to rotate. Code can also be provided to elements within the reconfigurable fabric so that the reconfigurable fabric can perform intended computational tasks such as logical operations including Boolean operations, matrix computations, tensor operations, mathematical operations, machine learning operations, gradient operations, etc. The various elements of the reconfigurable fabric can be controlled by the rotating circular buffers, where the one or more circular buffers can be of the same length or of differing lengths. Functions, routines, algorithms, instructions, codes, etc., can be loaded into a given circular buffer. The rotation of the given circular buffer ensures that the same series of coded steps or instructions is repeated as required by the processing tasks assigned to a processing element of the reconfigurable fabric. The one or more rotating circular buffers can be statically scheduled.

Machine learning uses data flow graph node parallel update. A data flow graph comprises nodes that perform computations and arcs that enable the flow of data between and among the various nodes. A first plurality of processing elements is configured within a reconfigurable fabric to implement a first portion of a data flow graph. The reconfigurable fabric can include other elements such as storage elements, switching elements, or communications paths. The nodes of the first portion of the data flow graph include at least one variable node. The variable nodes can include data, batches of training data, minibatches of training data, biases, and so on. The first portion of the data flow graph implements part of a neural network. The neural network can implement a learning network such as a machine learning (ML) network, a deep learning (DL) network, etc. The neural network or learning network can be based on a convolutional neural network (CNN), a recurrent neural network (RNN), etc. The variable nodes can include weights, biases, factors, parameters, etc., for the neural network. A second plurality of processing elements is configured within the reconfigurable fabric to implement a second portion of the data flow graph. The nodes of the second portion of the data flow graph include at least one additional variable node. The second portion of the data flow graph implements an additional part of the neural network. Training data is issued to the first plurality of processing elements. The training data that is issued can include batches of training data, minibatches of training data, and so on. The training data is used to update variables within the at least one variable node. Additional variables are updated within the at least one additional variable node. The updating is based on forwarding the training data from the first plurality of processing elements to the second plurality of processing elements. Additional training data can be forwarded from the first plurality of processing elements to the second plurality of processing elements. The additional training data can be based on data from the variables within the at least one variable node that was further updated. The neural network is trained based on the variables within the at least one variable node that were updated and the additional variables within the at least one additional variable node. Gradients are passed from the second plurality of processing elements to the first plurality of processing elements. The gradients are used to further update variables within the at least one variable node. The gradients that are used for the updates can be based on an average, a running average, a weighted average, an aggregation, and the like.

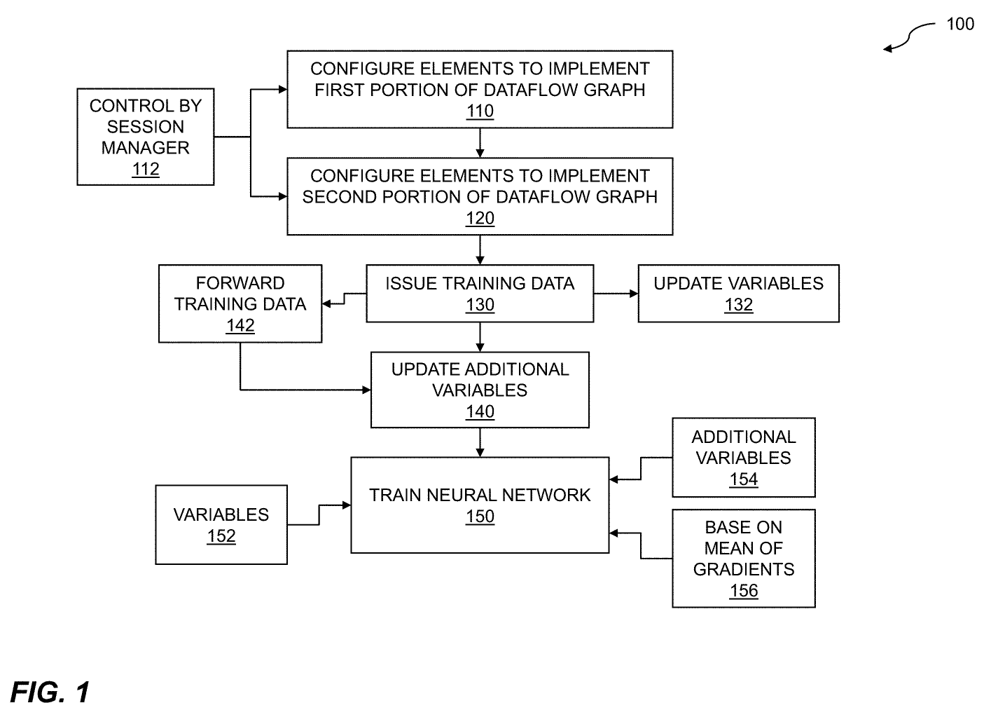

FIG. 1 is a flow diagram for data flow graph node parallel update for machine learning. The flow 100 includes configuring a first plurality of processing elements within a reconfigurable fabric to implement a first portion of a data flow graph 110. The data flow graph includes nodes and arcs, where the nodes can correspond to logical, mathematical, and other operations, and the arcs can correspond to flows of data. The data flow graph can represent machine learning or deep learning. The configuring of the reconfigurable fabric is controlled by a session manager 112. In embodiments, the nodes of the first portion of the data flow graph include at least one variable node. Parameters or values of the variable node can be adjusted, where the adjusting can be performed to improve data flow graph performance, convergence, and so on. In embodiments the first portion of the data flow graph implements part of a neural network. The data flow graph can be used for a variety of purposes. Embodiments include the data flow graph being used to train a neural network. The training of the neural network can be used for machine learning (ML), deep learning (DL), and other techniques. The neural network can be based on a variety of computational architectures. In embodiments, the neural network can include a convolutional neural network. The convolutional neural network can include a feeding forward of weights, biases, etc. In other embodiments, the neural network comprises a recurrent neural network. A recurrent neural network includes dynamic temporal behavior, where the dynamic temporal behavior can occur for a sequence of time.

The reconfigurable fabric within which the processing elements can be configured can include clusters of processing elements, where the clusters of processing elements can include quads of processing elements. The reconfigurable fabric can include other types of elements such as storage elements, switching elements, control elements, and so on. In embodiments, the processing elements can be controlled by circular buffers. The circular buffers can include rotating circular buffers. The rotating circular buffers can be same size or can be different sizes. The configuring of the processing elements can be accomplished by scheduling or loading commands, instructions, code, etc., into the circular buffers. The circular buffers can be statically scheduled. The commands scheduled in the circular buffers can be executed to perform operations on data. The operations can include processing operations, switching operations, and the like.

The flow 100 includes configuring a second plurality of processing elements within the reconfigurable fabric to implement a second portion of the data flow graph 120. As for the first plurality of processing elements, the second plurality of processing elements can be controlled by the session manager 112. The nodes of the second portion of the data flow graph can include at least one additional variable node. Parameters of the additional variable nodes can also be adjusted for various purposes such as to improve data flow graph performance, convergence, and so on. The adjusting the additional variable nodes can include adjusting weights or layers within neural networks, biases, etc. In embodiments the second portion of the data flow graph implements an additional part of the neural network. The flow 100 includes issuing training data 130 to the first plurality of processing elements. The training data can be partitioned into batches of training data. The batches of training data can be further partitioned into “minibatches” of training data. The batches or minibatches of training data can be applied to the first portion of the data flow graph, the second portion of the data flow graph, or to other portions of the data flow graph. In embodiments, the training data can be used to update variables 132 within the at least one variable node. As discussed throughout, the updating of variables can include adjusting weights or biases, etc. The weights can apply to layers within the neural network.

The flow 100 includes updating additional variables 140 within the at least one additional variable node. The additional variables can also include weights, biases, and so on. The updating can be based on forwarding the training data 142 from the first plurality of processing elements to the second plurality of processing elements. Other data may be forwarded. Further embodiments include forwarding additional training data from the first plurality of processing elements to the second plurality of processing elements. The additional training data can be based on data from the variables within the at least one variable node that was further updated. In other embodiments, the forwarding the training data includes N copies of a variable contained within the at least one variable node. The N copies are used for distribution within the data flow graph. The N copies of the variable can be distributed throughout the data flow graph using various techniques. The N copies can be propagated to variable nodes, can be propagated to non-variable nodes which can then further distribute the N copies, and so on. N can be an integer greater than or equal to 1 and can be less than or equal to the total number of nodes in the data flow graph.

The flow 100 includes training the neural network 150. The training of the neural network, such as the neural network for machine learning, deep learning, etc., can be based on the variables 152 within the at least one variable node that were updated and the additional variables 154 within the at least one additional variable node. The training can include back-propagation of updated variables, forward-propagation of updated variables, adjustments of layers, etc. The variables can include biases, factors, parameters, scales, etc. The updates can be used to learn or adjust weights of the neural network, to learn layers of the neural network, etc. The training can include parallel neural network training, distributed neural network training, and so on. The updates can be based on an average, a running average, a weighted average, an aggregation, and the like. In embodiments, the variables and the additional variables that were both updated can include a mean of gradients 156. The mean of gradients can be obtained or sourced from layers within a neural network, nodes from the data flow graph, etc. In embodiments, the mean of gradients can be sourced based on gradients from the first plurality of processing elements and the second plurality of processing elements. The mean of gradients can be sourced based on gradients from further pluralities of processing elements when further pluralities of processing elements have been configured for the data flow graph. Embodiments include training the neural network based on the mean of gradients. The mean of gradients can be used to accelerate the training of the neural network by updating weights based on processing of multiple minibatches of training data. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

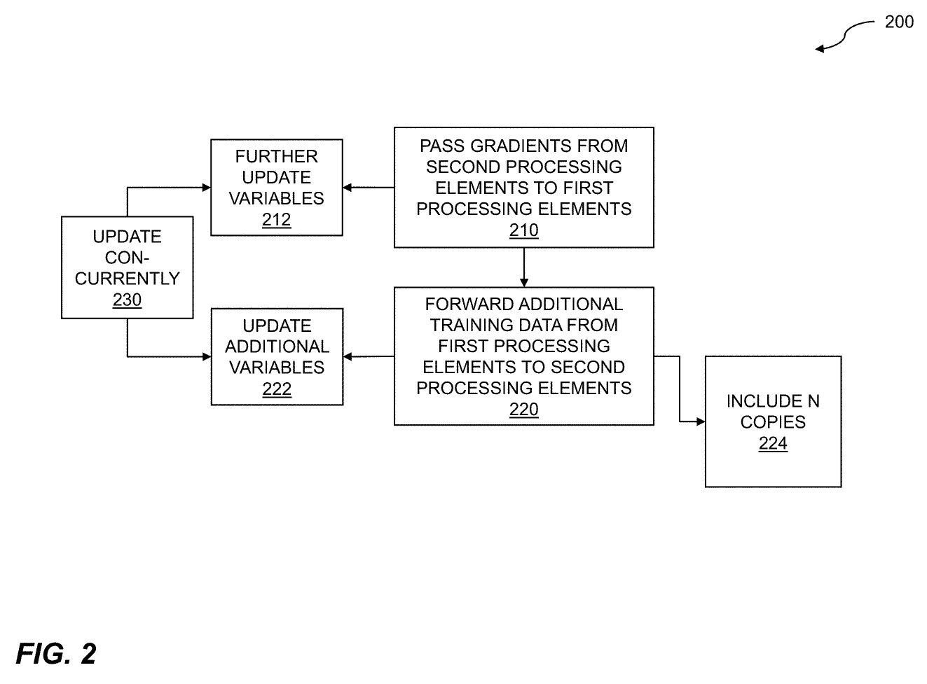

FIG. 2 is a flow diagram for parallel neural network training. A data flow graph can be used to represent a neural network such as a neural network for learning. The data flow graph shows nodes that process data as the data flows among the nodes of the graph. The nodes, which can be represented by agents, processing elements, and so on, can perform a variety of computations such as logical operations, matrix manipulations, tensor operations, Boolean operations, mathematical computations, and so on. Data flow graph node parallel update can be performed for machine learning. The data flow node parallel update can be performed within a reconfigurable fabric. A first plurality of processing elements within a reconfigurable fabric is configured to implement a first portion of a data flow graph. A second plurality of processing elements within the reconfigurable fabric is configured to implement a second portion of the data flow graph. Training data is issued to the first plurality of processing elements, where the training data is used to update variables. Additional variables are updated, where the updating is based on forwarding the training data from the first plurality of processing elements to the second plurality of processing elements.

The flow 200 includes passing gradients from the second plurality of processing elements to the first plurality of processing elements 210. The gradients can include adjustments to weights, such as ΔW, adjustments to biases, scaling factors, percentages, and so on. The gradients can be based on stochastic gradient descent (SGD), sub-gradient descent, etc. The gradients that are passed can be used to further update variables 212 within at least one variable node. The gradients can be used to train a neural network such as a machine learning network, a deep learning network, and so on. The training of the neural network can be used to improve computational efficiency of the neural network, convergence of the neural network, and so on. The flow 200 includes forwarding additional training data from the first plurality of processing elements to the second plurality of processing elements 220. The forwarding additional training data can include data that has been used by the first plurality of processing elements. The forwarding additional training data can be based on pipelining of the neural network for machine learning or deep learning. The additional training data can be based on or can include data from the variables within the at least one variable node that was further updated. The variables within a variable node that were updated can include weights, biases, etc., for layers of the neural network. The variables within the variable node can include gradients. In embodiments, the gradients can be used as part of the update process of the additional variables 222. The forwarding additional training data can be realized using one or more techniques. In embodiments, the forwarding the training data includes N copies 224 of a variable contained within the at least one variable node. The N copies can be used for distribution within the data flow graph. N can be an integer greater than or equal to 1 and less than or equal to the total number of nodes in the data flow graph. Note that a pipelined network, such as a neural network for a machine learning network or a deep learning network, can perform operations in parallel. In embodiments, the variables and the additional variables can be updated concurrently 230. The concurrent update of the variables and the additional variables can be used for training the neural network. In embodiments, the variables and the additional variables that are updated concurrently include parallel neural network training. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

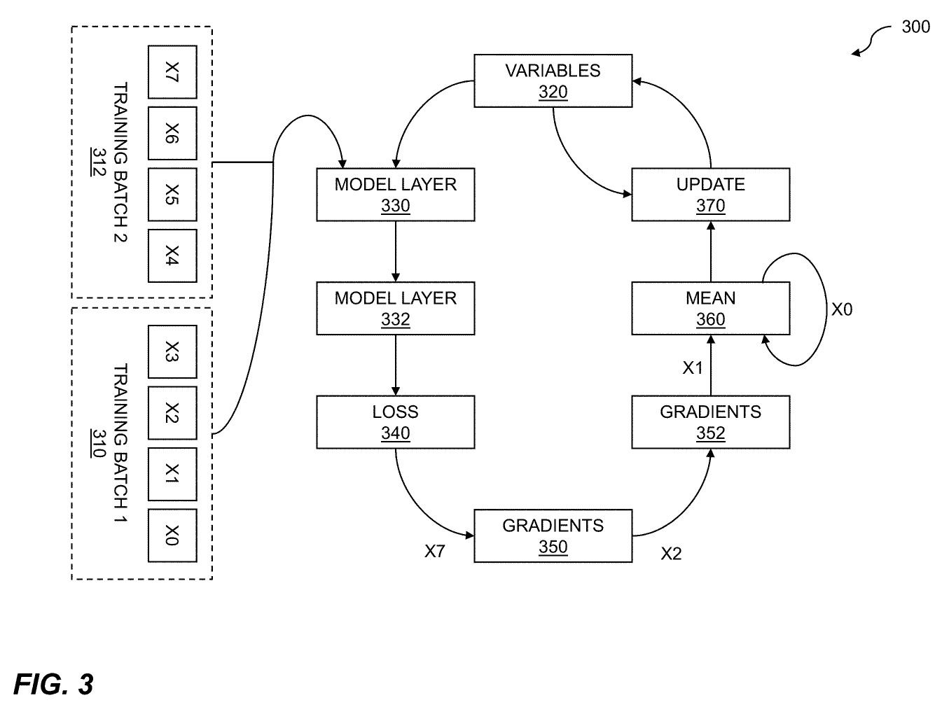

FIG. 3 shows variable updating which uses training minibatches 300. As discussed throughout, training of neural networks, such as neural networks for machine learning (ML), deep learning (DL), and so on, relies on very large datasets in order to be successful. The larger the datasets, the more closely variables such as neural network weights, biases, etc., can be tuned to improve neural network performance including convergence and accuracy. If the neural network can be pipelined, a technique in which multiple, different operations can be performed concurrently on subsets of data, then the training of the neural network can be accelerated. The acceleration results from performing a plurality of training steps in parallel. In order to take advantage of the pipelined neural network, small batches or “minibatches” of training data can be submitted or issued to the neural network in order to train the neural network. Variables such as weights for the neural network can then be tuned based on the operations on the minibatches of training data. These training minibatches support data flow graph node parallel update for machine learning.

Variable updating using training minibatches 300 is shown. Training data can be partitioned into batches, where the batches can be further partitioned into minibatches. Two training batches are shown, training batch 1 310 and training batch 2 312. Each training batch can include sub-batches or minibatches, such as training batch 1 including minibatches x0, x1, x2, and x3; and training batch 2 including minibatches x4, x5, x6, and x7. The minibatches of the training batches can be issued to a neural network such as a machine learning network or deep learning network. The minibatches can be issued as a series such as x0, x1, x2, and x3, to the neural network. A pipelined neural network can process the minibatches in parallel at each stage of the pipeline. In this example, the pipelined neural network can have inputs including the minibatches of training data and variables 320. The variables can include weights, adjustments to weights (ΔW), biases, and so on. The neural network can include multiple model layers such as model layer 330 and model layer 332. While two model layers are shown, other numbers of model layers can be included. The neural network can include a loss layer 340. The loss layer can perform operations such as a compression operation, a pooling or a max pooling operation, a rectified linear unit (ReLU) operation, a bottleneck layer operation, and so on. The one or more outputs of the loss layer can be analyzed, processed, etc., by one or more gradient layers such as a first layer of gradients 350, a second layer of gradients 352, and so on. While two gradient layers are shown, other numbers of gradient layers can be included. The gradients can include changes to weights as discussed elsewhere. The gradients can be based on stochastic gradient descent (SGD), sub-gradient descent, and so on. A mean 360 can be determined. The mean can include an average based on gradients, a running average, an average based on a number of minibatches, and so on. The mean can be used to update 370 a variable 320. The update can include adjusting a weight, a bias, etc., by the mean 360, either as a whole or proportionally. The update 370 can then adjust, replace, etc., the variable 320. Since the neural network in the example can be pipelined, multiple layers of the neural network can be processed in parallel. Considering an example of parallel pipelined processing minibatches from training batch 1, minibatch x3 can be applied to a first gradient, minibatch x2 can be applied to a second gradient, minibatch x1 can be applied to the mean, and minibatch x0 can be included in the computation of the mean. The computation of the mean can be based on the processing of each of the minibatches from training batch 1.

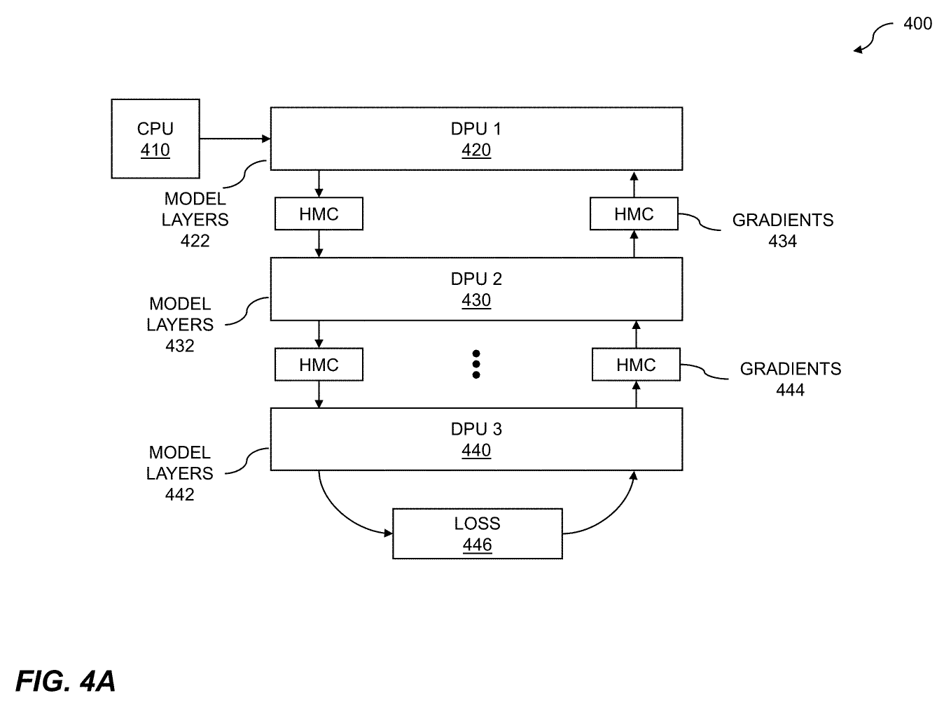

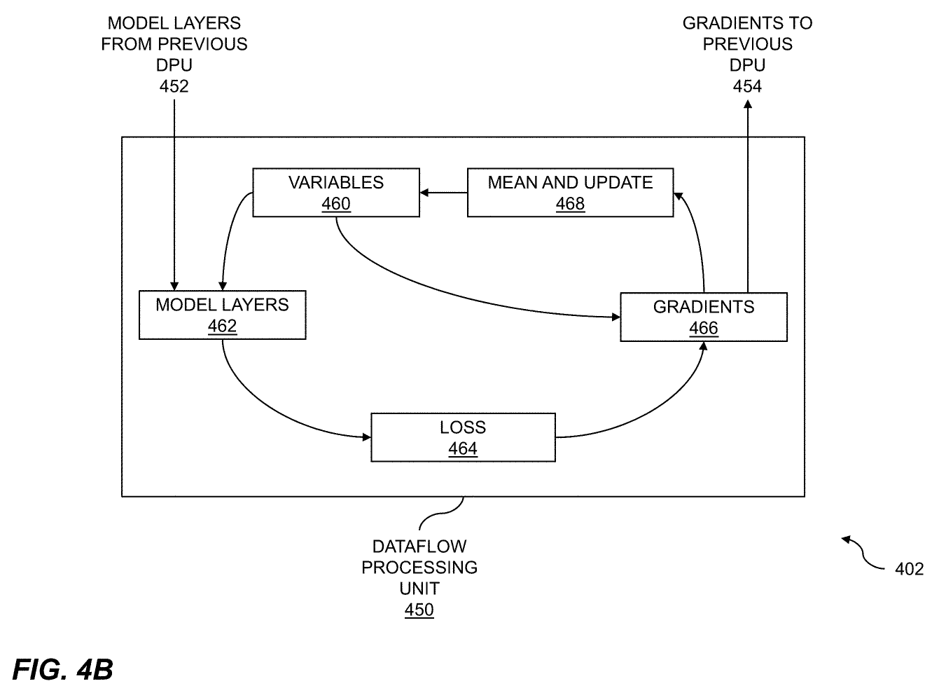

FIG. 4A illustrates scaling of variable training. A data flow graph can represent a network such as a neural network or other computational network. Training of neural networks such as machine learning (ML) networks, deep learning (DL) networks, and so on, is improved by applying increasingly larger datasets. The large datasets can include training datasets which are based on data that is known. The known data trains the network to identify data similar to or related to the known data. The time required to train the various types of learning networks also directly increases because the training data has to be processed, where the processing includes issuing the training data to the machine learning, deep learning, or other network. The time for training can in large part depend on the issuing of the data to the learning network and the retrieval or removal of results of the learning steps, such as updated variables, weights, biases, gradients, etc. Performing multiple learning iterations for two or more portions of the data flow graph, where the learning iterations can be performed in parallel, reduces the issuing of training data. Scaling of variable training supports data flow graph node parallel update for machine learning.

A central processing unit (CPU) 410 can apply training data to a learning network such as network 400. The CPU can be included in a host computer or other computer. The host computer can include a computing device such as a local computer, a remote computer, a cloud-based computer, a distributed computer, a mesh computer, and so on. The computer can run any of a variety of operating systems such as Unix™, Linux™, Windows™, MacOS™, and so on. The learning network can include multiple data flow processing units (DPU), where the DPUs can host portions of a data flow graph representing a neural network, a machine learning network, a deep learning network, and so on. Three DPUs are shown, DPU 1 420, DPU 2 430, and DPU 3 440. While three DPUs are shown, other numbers of DPUs can be included. A DPU can be configured to implement a portion of the data flow graph. Data can be passed between and among DPUs configured for the data flow graph of the learning network. In embodiments, data including model layers can be transferred between DPUs. The model layers can include one or more layers of the learning network. The model layers can include model layers 422, model layers 432, and model layers 442. These model layers are contained within their DPUs, DPU 1, DPU 2, and DPU 3, and so on respectively. The data such as the model layers can be held, stored, buffered, and so on. An HMC can be accessible by two or more DPUs. The HMCs can be located between DPUs, adjacent to DPUs, etc. In embodiments, the HMCs are coupled to a reconfigurable fabric of elements, where the elements include processing elements, switching elements, storage elements, and so on. The HMCs can facilitate passing data between the DPUs. Feature maps from one DPU can be passed to another DPU. These feature maps can be passed through one or more HMCs. A feature map can include identification of key features that are defined during learning and can be an output of a filter that is applied to another layer. The reconfigurable fabric can include quads of processing elements.

Other data can be transferred between DPUs. In embodiments, data including gradients can be transferred and this transfer can be facilitated by HMCs. The gradients can be used for updating variable nodes within the learning network represented by the data flow graph. The gradients can be used for optimization of the learning network, convergence and so on. The gradients can include gradients 444 passed between DPU 3 and DPU 2, etc. Embodiments further include passing gradients 434 from the second plurality of processing elements to the first plurality of processing elements. The gradients can be stored, buffered, etc., using hybrid memory cubes or other storage techniques. The gradients can be used to further update variables within the at least one variable node. One or more DPUs can include a loop such as a loop including loss 446. In embodiments, the loss loop can be coupled to or can be in communication with a DPU such as DPU 3 or another DPU. In other embodiments, the loss loop can be included within a DPU such as DPU 3. While one loss loop 446 is shown in communication with DPU 3, other loss loops can be coupled to or included within other DPUs. The loss loop can include a loss layer within a network such as a machine learning network, a deep learning network, or the like. The loss layer can include one or more techniques for processing data or training data, etc. The loss layer techniques can include compression techniques, pooling techniques such as max pooling techniques, rectified linear unit (ReLU) techniques, and the like. The loop can enable updating of variables within a variable node, updating of additional variables of other variable nodes, and the like. The loop can include a layer of the learning network. The layer can include a loss layer, a compression layer, a bottleneck layer, and so on. The loss function, along with the gradient calculation, can be referred to as backward propagation of errors with regard to deep learning. The gradients (e.g. gradient 444 and gradient 434) are calculated as part of the backward propagation and communicated through the HMCs as indicated in the return path from DPU 3 through DPU 1.

FIG. 4B is a block diagram for a data flow processing unit including loss 402. A data flow processing unit (DPU) can be configured, where the configuring can include configuring or scheduling processing elements within a reconfigurable fabric. The DPU can be configured to implement portions of or all of a data flow graph, subgraphs of the data flow graph, and so on. The data flow graph can represent a network such as a neural network, where the neural network can perform various techniques such as machine learning, deep learning, etc. The learning for machine learning, deep learning, etc., can include variable training. A data flow processing unit (DPU) such as a DPU used for variable training, can include loss. In embodiments, loss can be included within the DPU, coupled to the DPU, and so on. The DPU including loss can support data flow graph node parallel update for machine learning. A DPU 450 is shown. The DPU can accept inputs 452. The inputs to the DPU can include data such as model layers from a previous DPU, training data, raw data to be processed, and so on. In embodiments, the inputs to the DPU can be read from memory. The memory can include memory such as a hybrid memory cube (HMC) of dynamic random access memories (DRAM) and through silicon vias (TSVs) for interconnecting and controlling the DRAMs, direct memory access (DMA) storage, registers accessible by the DPU, etc. The DPU can generate outputs 454. The outputs from the DPU can include data such as gradients to a previous DPU, weights, biases, and the like. The DPU configured as a neural network for machine learning or deep learning can include nodes such as variable nodes 460 to store learning data, weights, biases, etc., layers such as learning model layers 462, and so on. The variables 460 are distributed to the model layers 462. Updated versions of the variables can similarly be distributed to the layers. By distributing the variables, the neural network is decentralized which allows scalability to an arbitrary number of layers. The neural network can also include variables such as gradients 466, and layers to compute a mean value and to perform and update 468. The mean value can be used to update the variables 460. The DPU can also include one or more loss layers. A loss layer, such as 464, can include various techniques, where the techniques can include pooling or max pooling, rectified linear unit (ReLU) techniques, compression techniques, and the like.

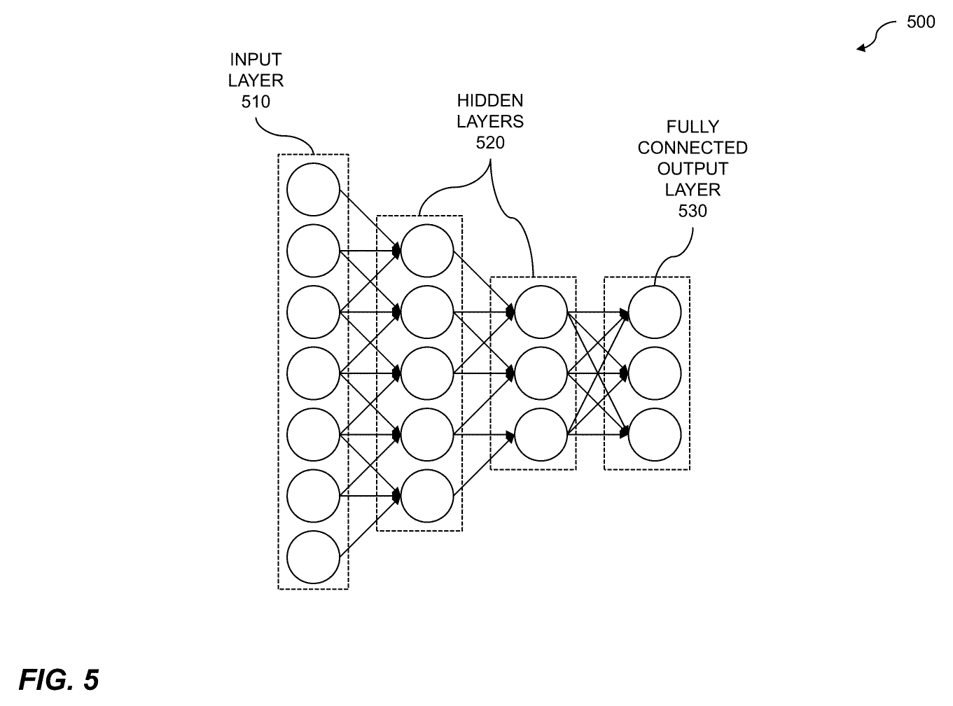

FIG. 5 shows a network for a data flow graph. A network such as a neural network can include various portions such as interconnects, communication channels, processing elements, storage elements, switching elements, and so on. A network can be implemented using one or more computing devices, a computational device, one or more processors, a reconfigurable fabric of processing elements, and the like. A network for executing a data flow graph can be assembled. A data flow graph is a representation of how various types of data, such as image data, training data, matrices, tensors, gradients, and so on, flow through a computational system. A data flow graph includes nodes and arcs, where the nodes represent operations on data, and the arcs represent the flow of data between and among the nodes. The operations of the nodes can be implemented using agents. The data flow graph can be implemented on the network by assigning processing elements, storage elements, switching elements, etc. to nodes or agents and to arcs of the data flow graph. The network can support data flow graph node parallel update for machine learning.

A network 500 is shown. The network includes layers, where the layers can include an input layer 510, an output layer, such as a fully connected output layer 530, and one or more hidden layers 520. The layers of the network can include one or more bottleneck layers. The network can include a deep neural network (DNN), a convolutional neural network (CNN), and so on. The network can implement a machine learning system. The input layer 510 can receive input data, where the input data can include sample data, test data, image data, audio data, matrices, tensors, and so on. The input layer can receive other data such as weights. The nodes of the input layer can perform an operation on the data, where the operation can include a multiplication, an addition, an accumulation (A=A+B), and so on. The input layer can be connected to one or more hidden layers 520. The hidden layers can perform a variety of operations on the input data and on other data such as bias values. The hidden layers can include one or more bottleneck layers. The bottleneck layer can include a layer that contains fewer nodes than the one or more preceding hidden layers. The bottleneck layer can create a constriction within the network. The bottleneck layer can force information that is pertinent to an inference, for example, into a lower dimensional representation. The one or more hidden layers can be connected to an output layer. In the example 500, the output layer can be a fully connected layer 530. In a fully connected layer, each node, agent, or neuron in a layer such as the output layer is coupled to each node of another layer. In the case of an output layer, each node of the output layer is coupled to each node of a preceding hidden layer. A fully connected layer can improve classification of data by examining all of the data in a previous layer rather than examining just a subset of the data. An equivalent convolutional layer can represent a fully connected layer. For computational reasons, a convolutional layer may be used in place of a fully connected layer.

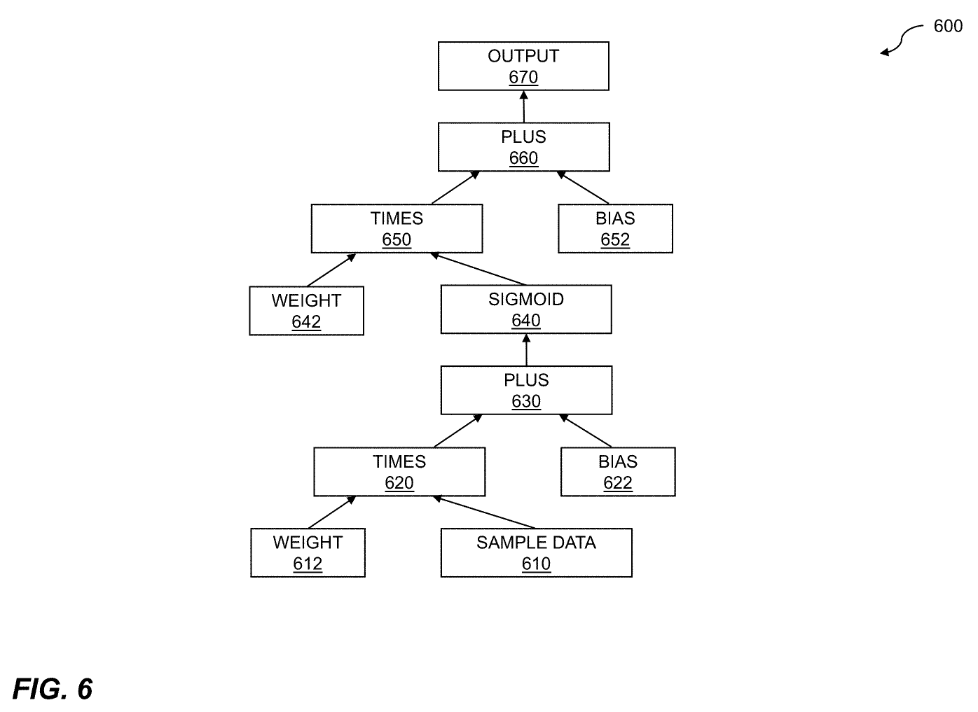

FIG. 6 illustrates a deep learning program graph. A program graph can be a computational representation of a data flow graph. The deep learning program graph can show operations and data flow for data flow graph node parallel update for machine learning. A program graph can show both the logical operations to be performed on data, and the flow of data between and among the logical operations. The program graph can show inputs, where the inputs can collect various types of data. The data can include test data, sample data, weights, biases, gradients, and so on. The program graph can show logical operations, where the logical operations can include Boolean operations, matrix operations, tensor operations, mathematical operations, gradient operations, and the like.

A deep learning (DL) program graph is shown 600. The deep learning program graph can include inputs and computational nodes. The inputs to the DL graph can include sample data 610 or test data, weights 612, and so on. The input data can include matrices, tensors, data files of images, and so on. The inputs can be operated on by a computation node. The computation node 620 can perform a multiplication of the weights 612 and the sample data 610. Other computational nodes can be included in the deep learning program graph. An addition node plus 630 can calculate a sum of the products or the partial products from times 620 and bias values 622. The bias values can be used to enhance performance of a deep neural network, such as a DL network, by improving convergence, improving inferences, etc. The one or more sums from the plus node 630 can be processed by a sigmoid node 640. A sigmoid node 640 can be used to perform an activation function such as a rectified linear unit (ReLU) operation, a hyperbolic tangent (tanh) operation, and so on. A further computation node 650 can perform a multiplication operation, times 650. The times operation can multiply the results of processing data with the sigmoid function by weights 642. A further computation node plus 660 can compute the sum of the products or the partial products from times 650 and bias values 652. The sums computed by plus 660 can be routed to an output node such as output node 670. Data can be collected from the output node for various purposes such as storage, processing by a further program graph, and so on.

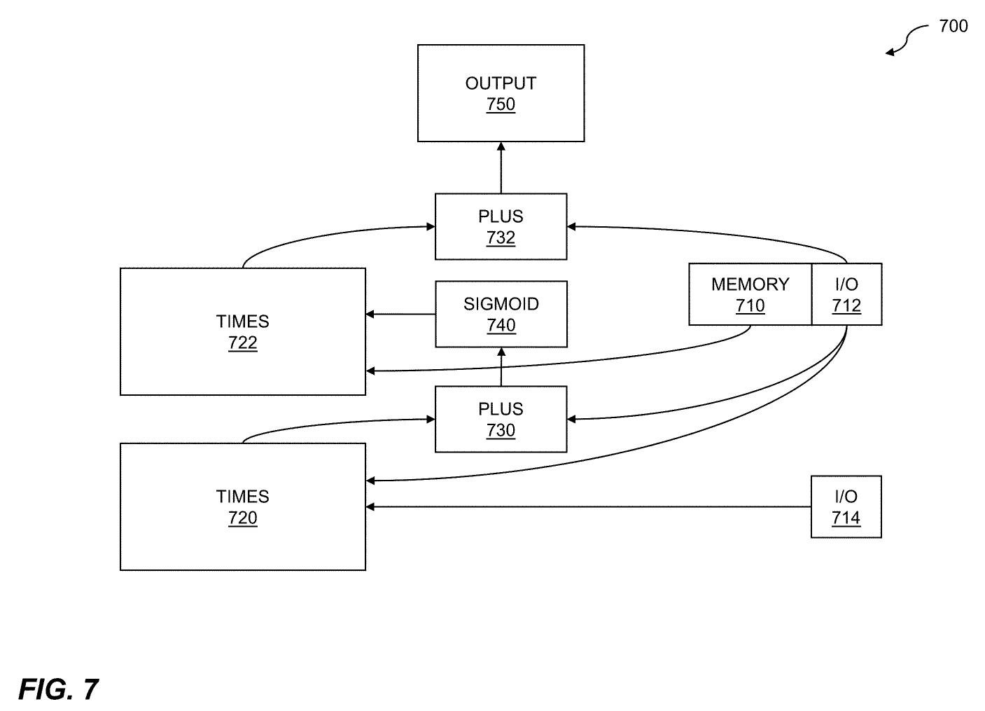

FIG. 7 shows an assembled data flow graph for runtime 700. In its most general sense, a data flow graph is an abstract construct which can describe the flow of a type of data from one or more inputs or input nodes, through processing nodes, to one or more output nodes. The processing nodes describe operations such as logical operations, matrix operations, tensor operations, Boolean operations, gradient operations, etc., that can be performed on that data. The processing operations of the nodes can be performed by agents. To execute the data flow graph, the data flow graph can be assembled at runtime. The assembly can include configuring data inputs/outputs, memory input/output, and so on. The assembled data flow graph can be executed on the data flow processor. The execution of the assembled data flow graph supports data flow graph node parallel update for machine learning.

The techniques for assembling the data flow graph for runtime can be analogous to classic compilation of code. The steps of compilation of code can include preprocessing, compiling, assembling, linking, and so on. Inputs and outputs can be assigned to input/output ports of a computing device, a reconfigurable fabric, etc.; buffers can be assigned to store, retime, or buffer data; agents can be assigned to processing elements; etc. The result of the linking can include an “execution module” or executable code that can be executed on a computing device. The executable code of the assembled data flow graph for runtime can be assigned to clusters of processing elements within the reconfigurable fabric. Processing elements of the reconfigurable fabric can be configured to implement the agents of the data flow graph by statically scheduling rotating circular buffers, where the rotating circular buffers can control the operation of the processing elements. A set of buffers can be initialized for an agent. The buffers can be located within or beyond the reconfigurable fabric.

An assembled data flow graph for runtime is shown. The assembled data flow graph can include memory 710 for storing data, intermediate results, weights, etc., input/output ports 712, and further input/output ports 714. The input/output ports can include assigned input/output ports of the reconfigurable fabric, communications paths through the fabric, and the like. The input/output ports can receive learning data, raw data, weights, biases, etc., and can send computation results, inferences, back-propagated weights, etc. The assembled data flow graph can include multiplication agents, such as a first times agent 720 and an additional times agent 722. The first times agent 720 can multiply sample data or test data by weights, the second times agent 722 can multiply weights by a sigmoid function 740, and so on. The assembled data flow graph can further include addition agents, such as a first plus agent 730 and second plus agent 732. The plus agent 730 can add partial products or products from times agent 720 to bias values. The plus agent 732 can add partial products or products from times agent 722 with bias values. The sums, partial sums, etc., that can be calculated by the add agent 732 can be output 750. The output can include computational results, inferences, weights, and so on.

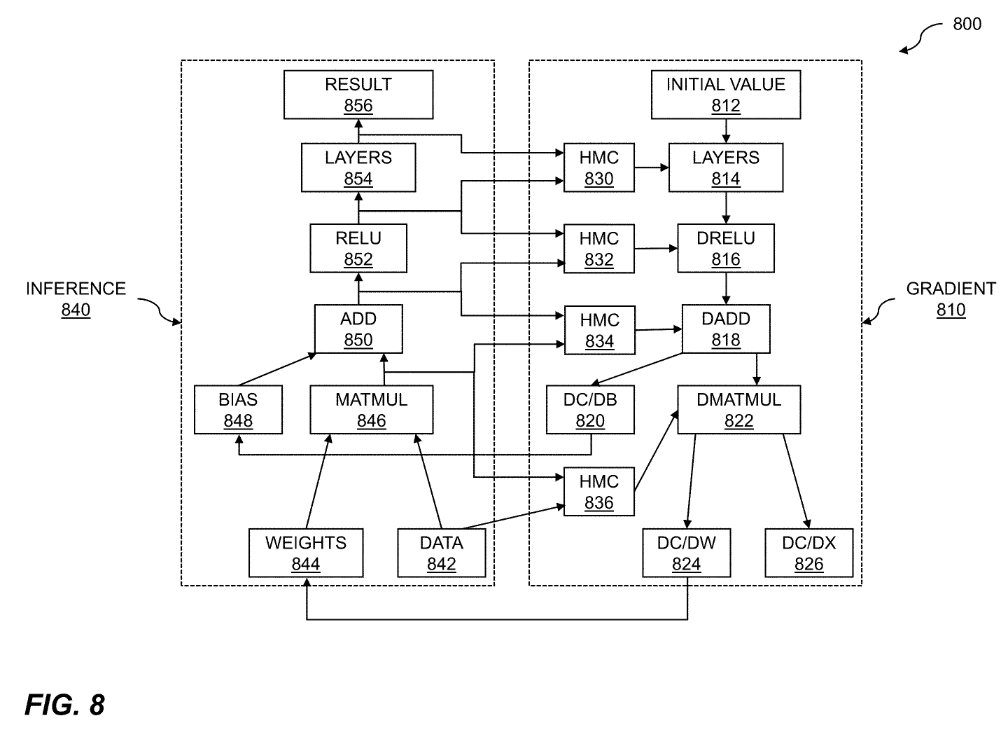

FIG. 8 illustrates batch processing for training. As discussed throughout, a data flow graph can represent a deep learning network. The deep learning network can be trained autonomously using data flow graph node parallel update for machine learning. The training of a deep neural network (DNN) for deep learning (DL) can be an iterative process in which data from a large dataset is applied to the DNN. The data in the large dataset can be preprocessed in order to improve training of the DNN. The DNN attempts to form inferences about the data, and errors associated with the inferences can be determined. Through various techniques such as back propagation and gradient-based analysis, weights of the DNN can be updated with an adjusted weight which can be proportional to an error function.

Training of a data flow graph for deep learning is shown 800. The deep learning network can include a gradient side 810 and an inference side 840. The gradient side can be used to perform gradient descent or other techniques for error analysis which can facilitate the determining of weights and adjustments to weights for the deep learning network. An initial value 812 can be provided at an input node of the gradient side. The initial value can be processed by layers 814 of the deep learning network, where the layers can include an input layer, hidden layers, an output layer, etc. Data such as error data from the inference side can be fed back to the gradient side by storing the data in a hybrid memory cube (HMC) 830. The data in the HMC can be fed into the layers 814 for reducing inference error. The network can include one or more differential rectified linear units (dReLU) 816. The dReLU can execute an activation function on data received from the layers and from an HMC 832. Data can be applied to a differential addition dAdd operation 818. The dAdd operation data can also include data that can be fed back from the inference portion of the deep learning network. Data such as error data from the inference portion of the DLN can be stored in HMC 834, and the dAdd operation can process that data. An output such as dC/dB 820 can be calculated, where C can indicate a differential result, and B can indicate a bias, where the bias can enhance DNN operation. The bias can be used to enable neurons of the DNN to fire as desired even for data values near or equal to zero. The gradient portion of the DLN can include a differential matrix multiplication (dMatMul) 822 operation. The dMatMul operation can process data output from the dAdd operation and data stored in HMC 836. The data stored in the HMC can include results from an operation such as a matrix multiplication operation, training data, and so on. The dMatMul operation can generate one or more outputs such as dC/dx 826, where C can indicate a differential result, and dC/dW 824, where W can indicate a differential weight.

The inference side 840 of the DNN can take as inputs data 842 such as training data, weights 844, which can include or be adjusted by the dC/dW values 824, and bias values 848, which can include or be adjusted by dC/dB values 820. The weights and the data can be processed by a matrix multiplication (MatMul) operation 846. The results of the MatMul operation can be added with the bias values 848 using an addition operation 850. The results of the addition operation can be processed using an activation function such as a sigmoid function. A sigmoid function can include a rectified linear unit (ReLU) 852 where f(x)=max(0,x), a hyperbolic tangent function, an error function, and so on. The inference side of the DNN can include one or more layers 854, where the layers can include an input layer, an output layer, hidden layers, a bottleneck layer, etc. The output of the DNN layers can include a result 856. The result can include an inference determined for data, training data, and the like and can be based on an error or difference between the calculated result and an anticipated result. The training can continue until a desired level of training error such as a minimum error or target error can be attained.

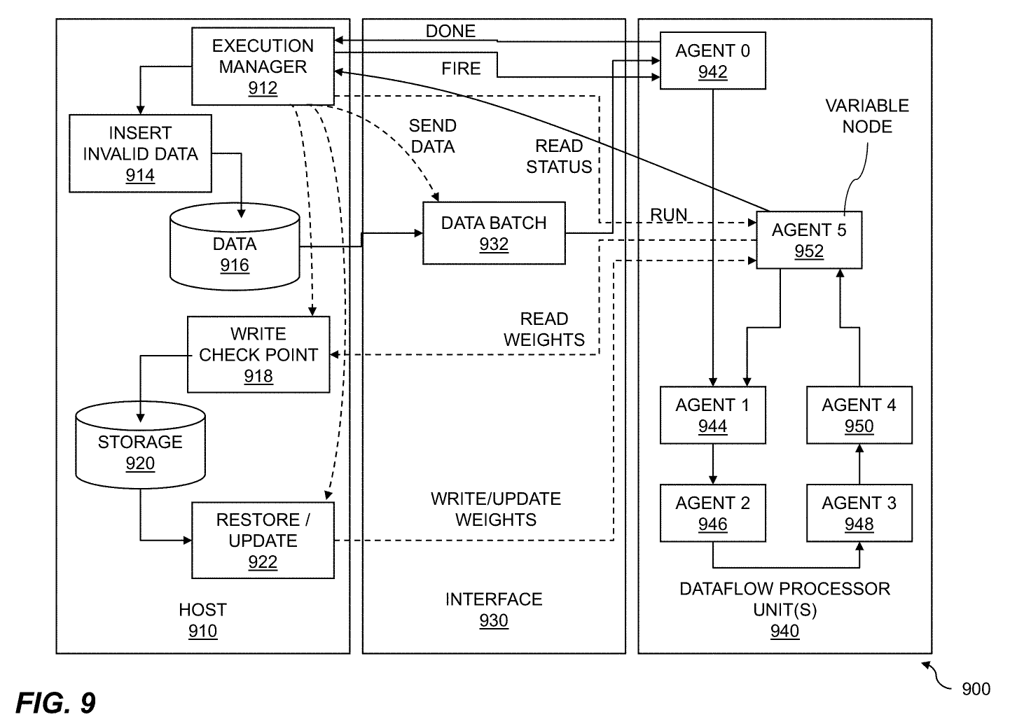

FIG. 9 shows execution manager operation. An execution manager can be associated with a data flow graph. The execution manager can perform a variety of tasks in support of the data flow graph. The tasks that can be performed by the execution manager can include providing data to input agents of the data flow graph, collecting output data from output agents, issuing fire signals to input agents of the data flow graph and receiving done signals from the input agents, sending done signals to the output agents and receiving done signals from the output agents, pausing and restarting data flow graph execution, and so on. The execution manager can enable data flow graph node parallel update for machine learning.

An example of execution manager operation is shown 900. The execution manager 912 can reside on a host 910, from which it can exert control on the flow of data 916. The host can include a computing device such as a local computer, a remote computer, a cloud-based computer, a distributed computer, a mesh computer, and so on. The computer can run any of a variety of operating systems such as Unix™, Linux™, Windows™, MacOS™, and so on. The control of the data flow by the execution manager can be supported by inserting invalid data 914 into the data 916. When invalid data is detected, execution of the agents in support of the data flow graph can be suspended. Suspending execution of the agents can including halting or suspending the agents and vacating the agents from a reconfigurable fabric which was configured to implement the data flow graph. Since the data flow graph can be reloaded onto the reconfigurable fabric, the states of the agents and the data associated with the agents can be collected. Embodiments include checkpointing a set of buffers for each node within the data flow graph, where the checkpointing is based on a node being paused. Checkpoints that result from the checkpointing can be written 918 into storage 920. The data flow graph that was vacated can be reloaded into the reconfigurable fabric. Further embodiments include restarting a paused data flow graph, wherein the restarting is accomplished by loading a set of checkpointed buffers. The checkpointed buffers can be restored or updated 922 into the reconfigurable fabric.

Execution manager operation can include accessing an interface 930. The interface can include an interface between the host 910 and data flow processor units (DPU) 940, discussed below. The interface can include a computing device interface such as a peripheral component interconnected express (PCIe or PCI-E) interface. The interface, such as the PCIe interface, can enable transfer of one or more signals such as control signals. The control signals can include fire and done signals for controlling one or more agents; a read weights signal to capture data from agents and buffers associated with agents, such as a variable node or agent, for checkpointing; write and update weights for updating a variable node; a data batch 932 which can include data sent by the execution manager; and so on. Execution manager operation can include one or more data flow processor units 940. The data flow processor units can include one or more reconfigurable fabrics, storage, and so on. The data flow processor units can be configured to implement a data flow graph. Elements or nodes of the data flow graph, such as agents, can be loaded onto the DPUs. The agents can include agent 0 942, which can include an input node, agent 1 944, agent 2 946, agent 3 948, agent 4 950, agent 5 952, and so on. Agent 5 can be a variable node, where a variable node or other nodes can be modified based on machine learning. The variable nodes can contain weights for deep learning. While six agents are shown loaded onto the DPUs, other numbers of agents can be loaded onto the DPUs. The other numbers of agents can be based on the data flow graphs implemented on the DPUs.

In embodiments, variable nodes, such as agent 5 952, can control or regulate the flow of data through a data flow graph, such as in a data flow graph implemented in data flow processor unit(s) 940. A variable node agent can issue N number of multiple copies of a variable for distribution, where N is an integer greater than 1 and less than or equal to the total number of nodes in a data flow graph. The N copies can be issued before the variable node agent stops to wait for an update. The N copies of the variable can be propagated to other agents implemented in other nodes, such as agent 1 944, agent 2 946, agent 3 948, and agent 4 950. Of course, additional agents may reside in additional nodes (not shown). An average of the N updates resulting from the N multiple copies of the variable that were issued can be used for distributed training of a neural network implemented as a data flow graph. In embodiments, two or more sets of N number of copies of the variable can be issued by a variable node and can be in flight in the data flow graph in order to enable two or more averages to be used for parallel training of different data for machine learning.

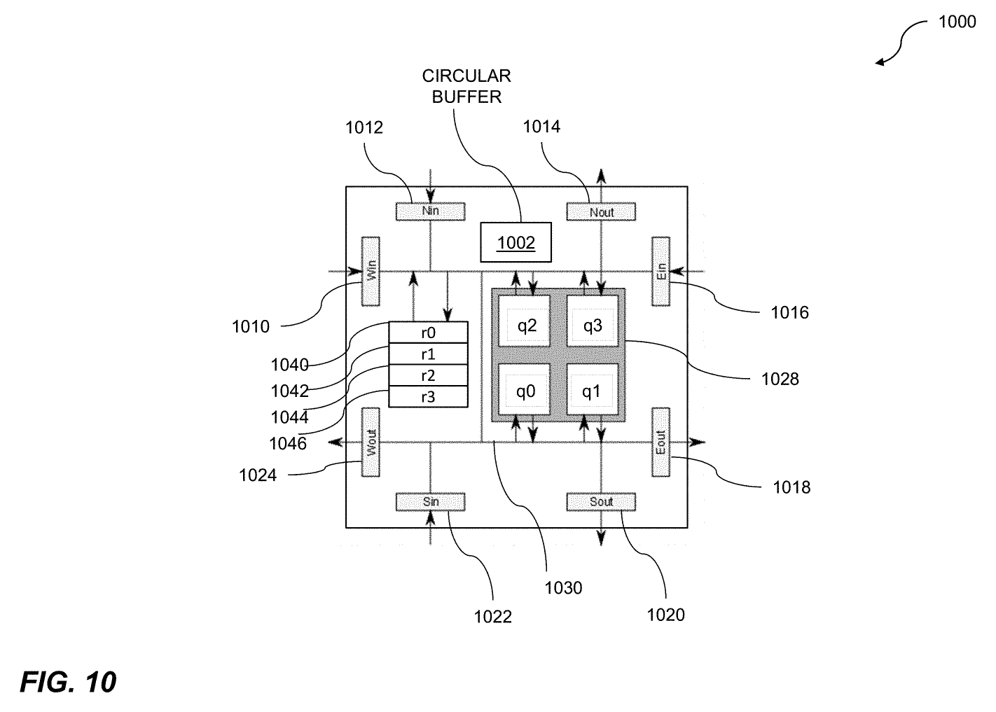

FIG. 10 shows a cluster for coarse-grained reconfigurable processing. The cluster for coarse-grained reconfigurable processing 1000 can be used for data flow graph node parallel update for machine learning. The machine learning can include accessing clusters on a reconfigurable fabric to implement the data flow graph. The processing elements such as clusters or quads of processing elements on the reconfigurable fabric can include processing elements, switching elements, storage elements, etc. The plurality of processing elements can be loaded with a plurality of process agents. A first plurality of processing elements can be configured within a reconfigurable fabric to implement a first portion of a data flow graph. The first portion of the data flow graph can implement part of a neural network. The nodes of the first portion of the data flow graph include at least one variable node. A second plurality of processing elements can be configured within the reconfigurable fabric to implement a second portion of the data flow graph. The nodes of the second portion of the data flow graph include at least one additional variable node. Training data can be issued to the processing elements, and additional variables can be updated. The updating can be based on forwarding the trained data from the first plurality of processing elements to the second plurality of processing elements.

The cluster 1000 comprises a circular buffer 1002. The circular buffer 1002 can be referred to as a main circular buffer or a switch-instruction circular buffer. In some embodiments, the cluster 1000 comprises additional circular buffers corresponding to processing elements within the cluster. The additional circular buffers can be referred to as processor instruction circular buffers. The example cluster 1000 comprises a plurality of logical elements, configurable connections between the logical elements, and a circular buffer 1002 controlling the configurable connections. The logical elements can further comprise one or more of switching elements, processing elements, or storage elements. The example cluster 1000 also comprises four processing elements—q0, q1, q2, and q3. The four processing elements can collectively be referred to as a “quad,” and can be jointly indicated by a grey reference box 1028. In embodiments, there is intercommunication among and between each of the four processing elements. In embodiments, the circular buffer 1002 controls the passing of data to the quad of processing elements 1028 through switching elements. In embodiments, the four processing elements 1028 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 1000 can further comprise storage elements coupled to the configurable connections. As shown, the cluster 1000 comprises four storage elements—r0 1040, r1 1042, r2 1044, and r3 1046. The cluster 1000 further comprises a north input (Nin) 1012, a north output (Nout) 1014, an east input (Ein) 1016, an east output (Eout) 1018, a south input (Sin) 1022, a south output (Sout) 1020, a west input (Win) 1010, and a west output (Wout) 1024. The circular buffer 1002 can contain switch instructions that implement configurable connections. For example, an instruction effectively connects the west input 1010 with the north output 1014 and the east output 1018 and this routing is accomplished via bus 1030. The cluster 1000 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 1002. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 1024 to an instruction placing data on the south output 1020, such that the data can be output on both output ports within the same pipeline cycle. In a case where data needs to travel to a cluster that is both south and west of the cluster 1000, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions North, East, South, West, a switch register, or one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed to enter configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

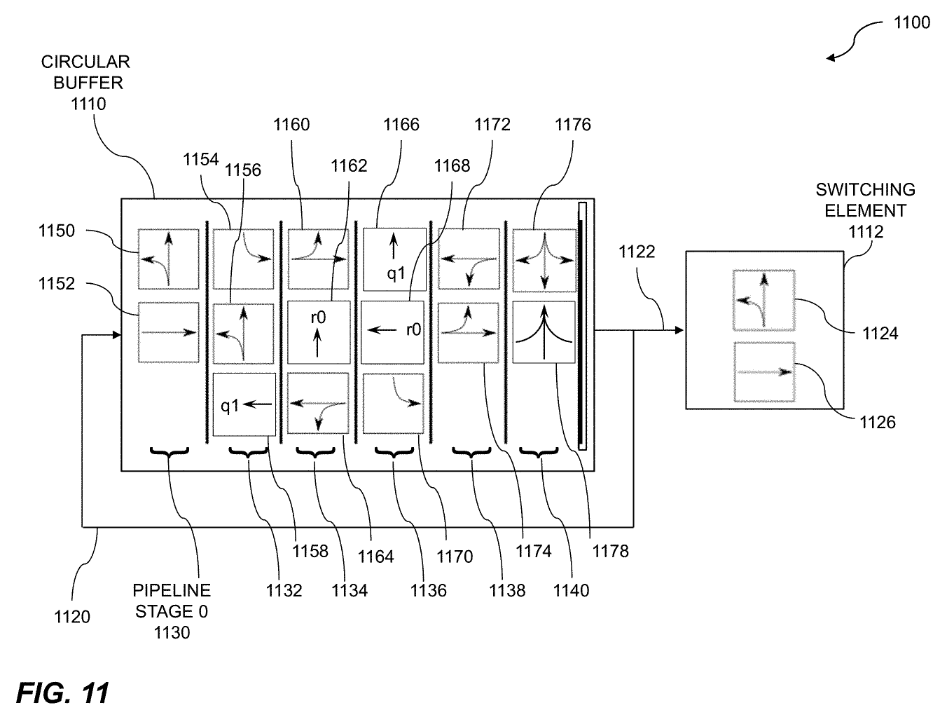

FIG. 11 shows a block diagram of a circular buffer. The circular buffer 1100 can include a switching element 1112 corresponding to the circular buffer. The circular buffer and the corresponding switching element can be used in part for data flow graph node parallel update for machine learning. Using the circular buffer 1110 and the corresponding switching element 1112, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1100 describes a processor-implemented method for data manipulation. The circular buffer 1110 contains a plurality of pipeline stages. Each pipeline stage contains one or more instructions, up to a maximum instruction depth. In the embodiment shown in FIG. 11, the circular buffer 1110 is a 6×3 circular buffer, meaning that it implements a six-stage pipeline with an instruction depth of up to three instructions per stage (column). Hence, the circular buffer 1110 can include one, two, or three switch instruction entries per column. In some embodiments, the plurality of switch instructions per cycle can comprise two or three switch instructions per cycle. However, in certain embodiments, the circular buffer 1110 supports only a single switch instruction in a given cycle. In the example 1100 shown, Pipeline Stage 0 1130 has an instruction depth of two instructions 1150 and 1152. Though the remaining pipeline stages 1-5 are not textually labeled in the FIG. 1100, the stages are indicated by callouts 1132, 1134, 1136, 1138, and 1140. Pipeline stage 1 1132 has an instruction depth of three instructions 1154, 1156, and 1158. Pipeline stage 2 1134 has an instruction depth of three instructions 1160, 1162, and 1164. Pipeline stage 3 1136 also has an instruction depth of three instructions 1166, 1168, and 1170. Pipeline stage 4 1138 has an instruction depth of two instructions 1172 and 1174. Pipeline stage 5 1140 has an instruction depth of two instructions 1176 and 1178. In embodiments, the circular buffer 1110 includes 64 columns. During operation, the circular buffer 1110 rotates through configuration instructions. The circular buffer 1110 can dynamically change operation of the logical elements based on the rotation of the circular buffer. The circular buffer 1110 can comprise a plurality of switch instructions per cycle for the configurable connections.

The instruction 1152 is an example of a switch instruction. In embodiments, each cluster has four inputs and four outputs, each designated within the cluster's nomenclature as “north,” “east,” “south,” and “west” respectively. For example, the instruction 1152 in the diagram 1100 is a west-to-east transfer instruction. The instruction 1152 directs the cluster to take data on its west input and send out the data on its east output. In another example of data routing, the instruction 1150 is a fan-out instruction. The instruction 1150 instructs the cluster to take data from its south input and send out on the data through both its north output and its west output. The arrows within each instruction box indicate the source and destination of the data. The instruction 1178 is an example of a fan-in instruction. The instruction 1178 takes data from the west, south, and east inputs and sends out the data on the north output. Therefore, the configurable connections can be considered to be time multiplexed.

In embodiments, the clusters implement multiple storage elements in the form of registers. In the example 1100 shown, the instruction 1162 is a local storage instruction. The instruction 1162 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1158 is a processing instruction. The instruction 1158 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1100 shown, the circular buffer 1110 rotates instructions in each pipeline stage into switching element 1112 via a forward data path 1122, and also back to a pipeline stage 0 1130 via a feedback data path 1120. Instructions can include switching instructions, storage instructions, and processing instructions, among others. The feedback data path 1120 can allow instructions within the switching element 1112 to be transferred back to the circular buffer. Hence, the instructions 1124 and 1126 in the switching element 1112 can also be transferred back to pipeline stage 0 as the instructions 1150 and 1152. In addition to the instructions depicted on FIG. 11, a no-op instruction can also be inserted into a pipeline stage. In embodiments, a no-op instruction causes execution to not be performed for a given cycle. In effect, the introduction of a no-op instruction can cause a column within the circular buffer 1110 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1158, assuming that the processor q1 was previously in a sleep state. In embodiments, when the instruction 1158 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1166. In the case of the instruction 1166, data from the processor q1 is moved to the north output. In some embodiments, if Xs have been placed into the processor q1, such as during the instruction 1158, then Xs would be retrieved from the processor q1 during the execution of the instruction 1166 and would be applied to the north output of the instruction 1166.

A collision occurs if multiple instructions route data to a particular port in a given pipeline stage. For example, if instructions 1152 and 1154 are in the same pipeline stage, they will both send data to the east output at the same time, thus causing a collision since neither instruction is part of a time-multiplexed fan-in instruction (such as the instruction 1178). To avoid potential collisions, certain embodiments use preprocessing, such as by a compiler, to arrange the instructions in such a way that there are no collisions when the instructions are loaded into the circular buffer. Thus, the circular buffer 1110 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 1162), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that calculates the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

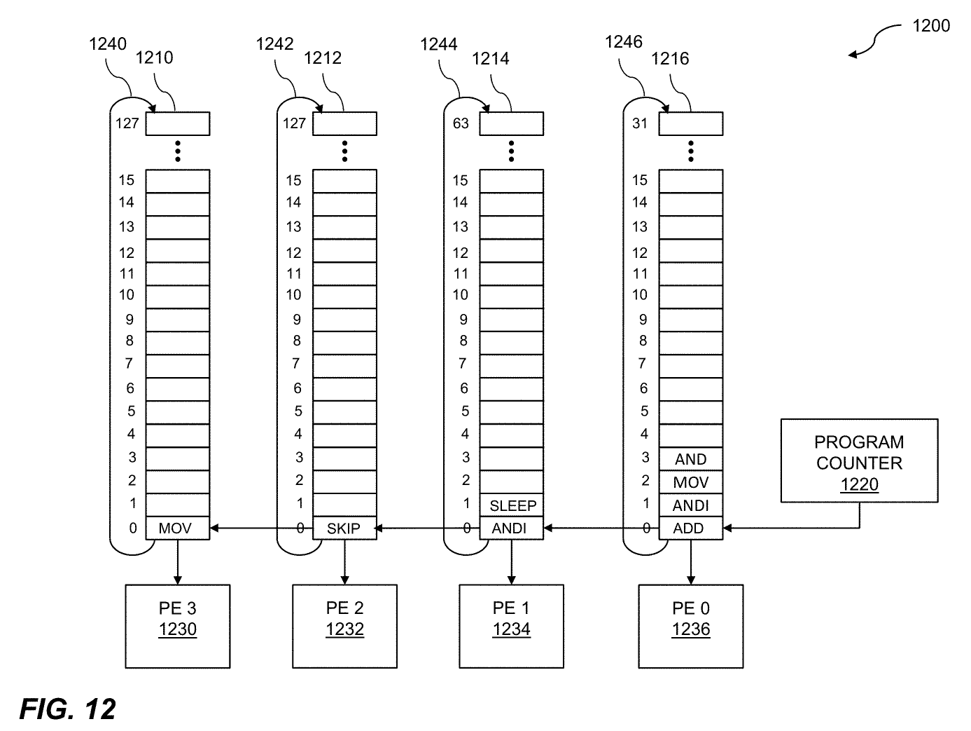

FIG. 12 illustrates circular buffers and processing elements. A diagram 1200 indicates example instruction execution for processing elements. The processing elements can include a portion of or all of the elements within a reconfigurable fabric. The instruction execution can include instructions for data flow graph node parallel update for machine learning. A circular buffer 1210 feeds a processing element 1230. A second circular buffer 1212 feeds another processing element 1232. A third circular buffer 1214 feeds another processing element 1234. A fourth circular buffer 1216 feeds another processing element 1236. The four processing elements 1230, 1232, 1234, and 1236 can represent a quad of processing elements. In embodiments, the processing elements 1230, 1232, 1234, and 1236 are controlled by instructions received from the circular buffers 1210, 1212, 1214, and 1216. The circular buffers can be implemented using feedback paths 1240, 1242, 1244, and 1246, respectively. In embodiments, the circular buffer can control the passing of data to a quad of processing elements through switching elements, where each of the quad of processing elements is controlled by four other circular buffers (as shown in the circular buffers 1210, 1212, 1214, and 1216) and where data is passed back through the switching elements from the quad of processing elements where the switching elements are again controlled by the main circular buffer. In embodiments, a program counter 1220 is configured to point to the current instruction within a circular buffer. In embodiments with a configured program counter, the contents of the circular buffer are not shifted or copied to new locations on each instruction cycle. Rather, the program counter 1220 is incremented in each cycle to point to a new location in the circular buffer. The circular buffers 1210, 1212, 1214, and 1216 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the first two circular buffers 1210 and 1212 have a length of 128 instructions, the third circular buffer 1214 has a length of 64 instructions, and the fourth circular buffer 1216 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 12, different circular buffers can have different instruction sets within them. For example, the first circular buffer 1210 contains a MOV instruction. The second circular buffer 1212 contains a SKIP instruction. The third circular buffer 1214 contains a SLEEP instruction and an ANDI instruction. The fourth circular buffer 1216 contains an AND instruction, a MOVE instruction, an ANDI instruction, and an ADD instruction. The operations performed by the processing elements 1230, 1232, 1234, and 1236 are dynamic and can change over time, based on the instructions loaded into the respective circular buffers. As the circular buffers rotate, new instructions can be executed by the respective processing element.

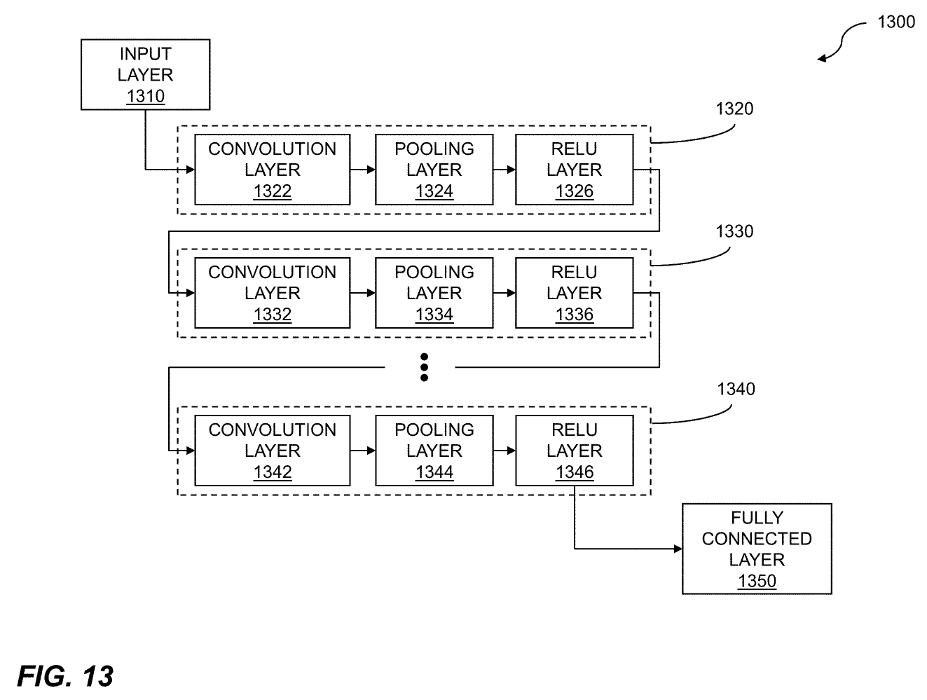

FIG. 13 shows a deep learning block diagram. The deep learning block diagram 1300 can include a neural network such as a deep neural network (DNN), a convolutional neural network (CNN), a recurrent neural network (RUN), and so on. A convolutional neural network can be based on layers, where the layers can include input layers, output layers, fully connected layers, convolution layers, pooling layers, rectified linear unit (ReLU) layers, bottleneck layers, and so on. The layers of the convolutional network can be implemented using a reconfigurable fabric. The reconfigurable fabric can include processing elements, switching elements, storage elements, etc. The reconfigurable fabric can be used to perform various operations such as logical operations. Deep learning can be applied to data flow graph node parallel update for machine learning.

A deep learning block diagram 1300 is shown. The block diagram can include various layers, where the layers can include an input layer, hidden layers, a fully connected layer, and so on. In some embodiments, the deep learning block diagram can include a classification layer. The input layer 1310 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 1300, which can represent a network such as a convolutional neural network, can contain a plurality of hidden layers. While three hidden layers, a first hidden layer 1320, a second hidden layer 1330, and a third hidden layer 1340 are shown, other numbers of hidden layers may be present. Each hidden layer can include layers that perform various operations, where the various layers can include a convolution layer, a pooling layer, and a rectifier layer such as a rectified linear unit (ReLU) layer. Thus, a first layer 1320 can include a convolution layer 1322, a pooling layer 1324, and a ReLU layer 1326; a second layer 1330 can include a convolution layer 1332, a pooling layer 1334, and a ReLU layer 1336; and a third layer 1340 can include a convolution layer 1342, a pooling layer 1344, and a ReLU layer 1346. The convolution layers 1322, 1332, and 1342 can perform convolution operations; the pooling layers 1324, 1334, and 1344 can perform pooling operations, including max pooling, such as data down-sampling; and the ReLU layers 1326, 1336, and 1346 can perform rectification operations. A convolutional layer can reduce the amount of data feeding into a fully connected layer. The block diagram 1300 can include a fully connected layer 1350. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

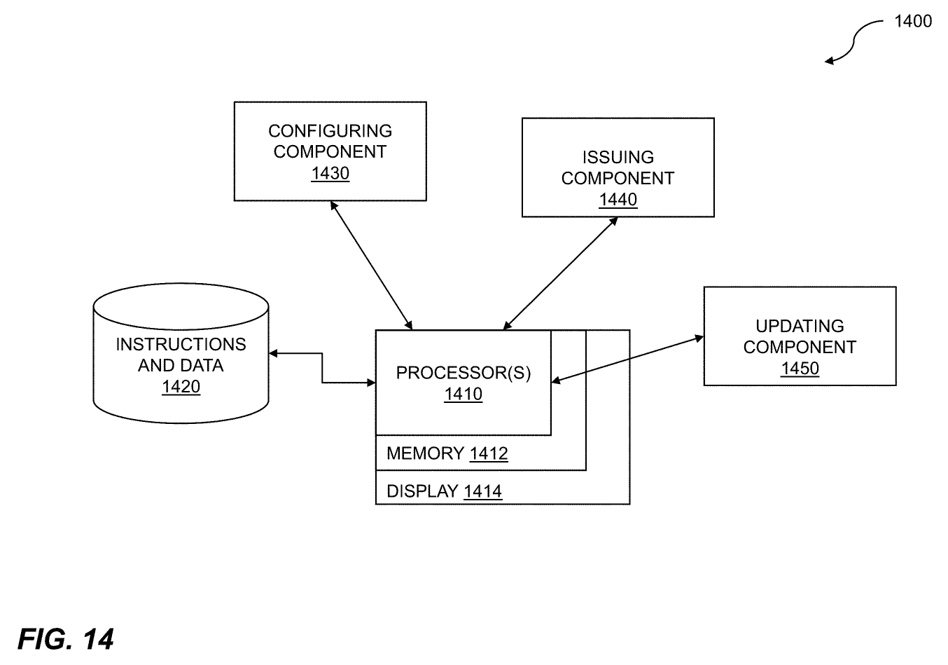

FIG. 14 is a system for a data flow graph node parallel update for machine learning. The system 1400 can include one or more processors 1410 coupled to a memory 1412 which stores instructions. The system 1400 can include a display 1414 coupled to the one or more processors 1410 for displaying data, intermediate steps, instructions, and so on. In embodiments, one or more processors 1410 are attached to the memory 1412 where the one or more processors, when executing the instructions which are stored, are configured to: configure a first plurality of processing elements within a reconfigurable fabric to implement a first portion of a data flow graph, wherein the nodes of the first portion of the data flow graph include at least one variable node, and wherein the first portion of the data flow graph implements part of a neural network; configure a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network; issue training data to the first plurality of processing elements, wherein the training data is used to update variables within the at least one variable node; and update additional variables within the at least one additional variable node, wherein the updating is based on forwarding the training data from the first plurality of processing elements to the second plurality of processing elements.

The system 1400 can include a collection of instructions and data 1420. The instructions and data 1420 may be stored in a database, one or more statically linked libraries, one or more dynamically linked libraries, precompiled headers, source code, flow graphs, kernels, agents, or other suitable formats. The instructions can include instructions for data flow graph node parallel update for machine learning. The data can include unstructured data, matrices, tensors, layers, and weights that can be associated with a convolutional neural network, gradients, etc. The instructions can include a static schedule for controlling one or more rotating circular buffers. The system 1400 can include a configuring component 1430. The configuring component 1430 can include functions, instructions, or code for configuring a first plurality of processing elements within a reconfigurable fabric to implement a first portion of a data flow graph. The plurality of processing elements can include clusters of processing elements. The clusters on the reconfigurable fabric can include quads of elements such as processing elements. The reconfigurable fabric can further include other elements such as storage elements, switching elements, and the like. The configuring component 1430 also can include functions, instructions, or code for configuring a second plurality of processing elements within the reconfigurable fabric to implement a second portion of the data flow graph. The variable nodes, the additional variable nodes, and other nodes of the data flow graph can be assigned to processing elements of a reconfigurable fabric. The processing elements can be configured to perform logical operations such as Boolean operations, matrix operations, tensor operations, mathematical operations, and so on, where the logical operations are related to the data flow graph. In embodiments, the configuring can be controlled by a session manager. The session manager can partition the data flow graph and can map the partitions to processing elements of the reconfigurable fabric

The system 1400 can include an issuing component 1440. The issuing component 1440 can include functions and instructions for issuing training data to the first plurality of processing elements. The training data can used to update variables within the at least one variable node. The training data can include batches of training data, where the batches of training data can include minibatches of training data. The training data can be forwarded from one plurality of processing elements to another plurality of processing elements. Additional training data can be forwarded from the first plurality of processing elements to the second plurality of processing elements. The system 1400 can include an updating component 1450. The updating component can include functions and instructions for updating additional variables within the at least one additional variable node. The updating can be based on forwarding the training data from the first plurality of processing elements to the second plurality of processing elements. In embodiments, gradients are used as part of the update process of the additional variables. The gradients can be used as part of gradient descent or sub-gradient decent techniques to improve machine learning by the neural network. The variables and the additional variables can be updated concurrently since the variables and the additional variables are associated with nodes of separate portions of a data flow graph. The variables and the additional variables that can be updated concurrently can include parallel neural network training.

The system 1400 can include a computer program product embodied in a non-transitory computer readable medium for data manipulation, the computer program product comprising code which causes one or more processors to perform operations of: configuring a first plurality of processing elements within a reconfigurable fabric to implement a first portion of a data flow graph, wherein the nodes of the first portion of the data flow graph include at least one variable node, and wherein the first portion of the data flow graph implements part of a neural network; configuring a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network; issuing training data to the first plurality of processing elements, wherein the training data is used to update variables within the at least one variable node; and updating additional variables within the at least one additional variable node, wherein the updating is based on forwarding the training data from the first plurality of processing elements to the second plurality of processing elements.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
configuring a first plurality of processing elements within a reconfigurable fabric to implement a first portion of a data flow graph, wherein nodes of the first portion of the data flow graph include at least one variable node, and wherein the first portion of the data flow graph implements part of a neural network;
configuring a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network;
issuing training data to the first plurality of processing elements, wherein the training data is used to update variables within the at least one variable node; and
updating additional variables within the at least one additional variable node, wherein the updating is based on forwarding the training data from the first plurality of processing elements to the second plurality of processing elements.

2. The method of claim 1 further comprising training the neural network based on the variables within the at least one variable node that were updated and the additional variables within the at least one additional variable node.

3. The method of claim 1 further comprising passing gradients from the second plurality of processing elements to the first plurality of processing elements, wherein the gradients are used to further update variables within the at least one variable node.

4. The method of claim 3 further comprising forwarding additional training data from the first plurality of processing elements to the second plurality of processing elements, wherein the additional training data is based on data from the variables within the at least one variable node that were further updated.

5. The method of claim 3 wherein the gradients are used as part of the updating of the additional variables.

6. The method of claim 1 wherein the variables and the additional variables are updated concurrently.

7. The method of claim 6 wherein the variables and the additional variables that are updated concurrently comprise parallel neural network training.

8. The method of claim 1 wherein the forwarding the training data includes N copies of a variable contained within the at least one variable node, wherein the N copies are used for distribution within the data flow graph, and wherein N is an integer greater than or equal to 1 and less than or equal to a total number of nodes in the data flow graph.

9. The method of claim 1 wherein the variables and the additional variables that were both updated include a mean of gradients.

10. The method of claim 9 wherein the mean of gradients is sourced based on gradients from the first plurality of processing elements and the second plurality of processing elements.

11. The method of claim 10 further comprising training the neural network, based on the mean of gradients.

12. The method of claim 1 wherein the data flow graph comprises machine learning or deep learning.

13. The method of claim 1 wherein the configuring is controlled by a session manager.

14. The method of claim 1 wherein the processing elements are controlled by circular buffers.

15. The method of claim 14 wherein the circular buffers are statically scheduled.

16. The method of claim 1 wherein data flow graph is used to train a neural network.

17-18. (canceled)

19. The method of claim 1 wherein the reconfigurable fabric comprises processing elements.

20. The method of claim 19 wherein the processing elements are controlled by circular buffers.

21. (canceled)

22. A computer program product embodied in a non-transitory computer readable medium for data manipulation, the computer program product comprising code which causes one or more processors to perform operations of:
configuring a first plurality of processing elements within a reconfigurable fabric to implement a first portion of a data flow graph, wherein nodes of the first portion of the data flow graph include at least one variable node, and wherein the first portion of the data flow graph implements part of a neural network;
configuring a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network;
issuing training data to the first plurality of processing elements, wherein the training data is used to update variables within the at least one variable node; and
updating additional variables within the at least one additional variable node, wherein the updating is based on forwarding the training data from the first plurality of processing elements to the second plurality of processing elements.

23. A computer system for data manipulation comprising:
a memory which stores instructions;
one or more processors attached to the memory wherein the one or more processors, when executing the instructions which are stored, are configured to:
configure a first plurality of processing elements within a reconfigurable fabric to implement a first portion of a data flow graph, wherein nodes of the first portion of the data flow graph include at least one variable node, and wherein the first portion of the data flow graph implements part of a neural network;
configure a second plurality of processing elements within the reconfigurable fabric to implement a second portion of the data flow graph, wherein the nodes of the second portion of the data flow graph include at least one additional variable node, and wherein the second portion of the data flow graph implements an additional part of the neural network;
issue training data to the first plurality of processing elements, wherein the training data is used to update variables within the at least one variable node; and
update additional variables within the at least one additional variable node, wherein the updating is based on forwarding the training data from the first plurality of processing elements to the second plurality of processing elements.
